(19) United States
(12) Patent Application Publication
(10) Pub. No.: US 2022/0129497 A1
(43) Pub. Date: Apr. 28, 2022

(54) SYSTEMS AND METHODS FOR FILTERING PRODUCTS BASED ON IMAGES

(71) Applicant: COUPANG Corp., Seoul (KR)

(72) Inventors: Shusong JIN, Shanghai (CN); Amir Reza Aghamousa FARASHI, Seoul (KR); Suhwan AHN, Seoul (KR)

(21) Appl. No.: 17/079,414

(22) Filed: Oct. 23, 2020

(51) Int. Cl. G06F 16/55; G06K 9/62; G06F 16/535; G06F 16/538; G06N 3/08

(52) U.S. Cl. CPC G06F 16/55; G06K 9/627; G06N 3/08; G06F 16/535; G06F 16/538; G06K 9/6202

(57) ABSTRACT

A method for filtering products based on images, comprising the steps of: receiving image data representing an image, the image being associated with a product identifier; analyzing the image data by a plurality of machine learning models; generating a plurality of image scores for the image, each image score being generated by each of the plurality of machine learning models; determining, based on the plurality of image scores, whether the image has a sensitive status; and assigning an unsafe category to the product identifier associated with the image having the sensitive status.

### TECHNICAL FIELD

The present disclosure generally relates to computerized systems and methods for filtering products based on images. In particular, embodiments of the present disclosure relate to inventive and unconventional systems relate to filtering products associated with unsafe images.

### BACKGROUND

In the field of on-line retail business, a variety of products are displayed in interfaces, such as a webpage, to potential shoppers. It is common to display the products by displaying pictures, graphic art, or images of the product, as these visual representations of product convey information to shoppers that text description could not.

Certain products may be associated images that are unsafe for display. An image may be unsafe if it depicts subject matter that may create offense to viewers, or be considered illegal. For example, nude images, or images that contain sexually suggestive subject matter may be considered unsafe for display. Therefore, these images, and products that may be associated with these images should be prevented from being displayed in many situations.

Existing methods and systems rely on individuals to screen and identify these images and flag them in the system. This is inefficient, and can be impractical if the quantity of images that need screening is large. Therefore, there is a need for improved methods and systems with to ensure that unsafe images are screened and identified in an efficient manner.

### SUMMARY

One aspect of the present disclosure is directed to a method for filtering products based on images, comprising the steps of: receiving image data representing an image, the image being associated with a product identifier; analyzing the image data by a plurality of machine learning models; generating a plurality of image scores for the image, each image score being generated by each of the plurality of machine learning models; determining, based on the plurality of image scores, whether the image has a sensitive status; and assigning an unsafe category to the product identifier associated with the image having the sensitive status.

Another aspect of the present disclosure is directed to a computerized system for filtering products based on images, comprising: at least one processor; a memory comprising instructions that, when executed by the at least one processor, performs steps comprising: receiving image data representing an image, the image being associated with a product identifier; analyzing the image data by a plurality of machine learning models; generating a plurality of image scores for the image, each image score being generated by each of the plurality of machine learning models; determining, based on the plurality of image scores, whether the image has a sensitive status; and assigning an unsafe category to the product identifier associated with the image having the sensitive status.

Yet another aspect of the present disclosure is directed to a system for filtering items based on images, comprising; one or more processors; memory storage media containing instructions to cause the one or more processors to execute the steps of: receiving information uploaded to a database, the information contain at least a product identifier and one or more images associated with the product identifier; analyzing each of the one or more images by a plurality of machine learning models, the plurality of machine learning models comprises: a neural network nudity detector configured to generate a first image score; a convolutional neural network object detector configured to generate a second image score; and a compound scaled convolutional neural network object detector configured to generate a third image score; determining based on the first image score, the second image score, and the third image score, whether each of the one or more images has a sensitive status; and upon determination: assigning an unsafe category to the product identifier associated with images having the sensitive status.

Other systems, methods, and computer-readable media are also discussed herein.

### BRIEF DESCRIPTION OF THE DRAWINGS

FIG. 1A is a schematic block diagram illustrating an exemplary embodiment of a network comprising computerized systems for communications enabling shipping, transportation, and logistics operations, consistent with the disclosed embodiments.

FIG. 1B depicts a sample Search Result Page (SRP) that includes one or more search results satisfying a search request along with interactive user interface elements, consistent with the disclosed embodiments.

FIG. 1C depicts a sample Single Detail Page (SDP) that includes a product and information about the product along with interactive user interface elements, consistent with the disclosed embodiments.

FIG. 1D depicts a sample Cart page that includes items in a virtual shopping cart along with interactive user interface elements, consistent with the disclosed embodiments.

FIG. 1E depicts a sample Order page that includes items from the virtual shopping cart along with information regarding purchase and shipping, along with interactive user interface elements, consistent with the disclosed embodiments.

FIG. 2 is a diagrammatic illustration of an exemplary fulfillment center configured to utilize disclosed computerized systems, consistent with the disclosed embodiments.

FIG. 3 is a diagrammatic illustration of an exemplary system for filtering products with unsafe images, consistent with the disclosed embodiments.

FIG. 4 is a diagrammatic illustration of an exemplary machine learning architecture for filtering products with unsafe images, consistent with the disclosed embodiments.

FIG. 5 is a flow chart depicting an exemplary process for filtering products with unsafe images, consistent with the disclosed embodiments.

FIG. 6 is a diagrammatic illustration of an exemplary system for filtering search results, consistent with the disclosed embodiments.

### DETAILED DESCRIPTION

The following detailed description refers to the accompanying drawings. Wherever possible, the same reference numbers are used in the drawings and the following description to refer to the same or similar parts. While several illustrative embodiments are described herein, modifications, adaptations and other implementations are possible. For example, substitutions, additions, or modifications may be made to the components and steps illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope of the invention is defined by the appended claims.

In some cases, existing image recognition systems may only be able to reliably identify images that contain photographs or other realistic depictions of human. However, even images that do not depict nude humans may be unsafe; thus systems relying solely on nudity detection may be inadequate. Moreover, existing methods and systems of image recognition generally lack reliability when used to recognize nude images that are stylized or abstract, as is the case in certain comic or manga images. Thus, existing and conventional methods and systems of image recognition are often unsuitable to the requirement of recognizing unsafe images beyond the narrow scope of nudity, or may not be applicable across diverse types of images beyond photographs. Thus, conventional image recognition systems and methods cannot reliably replace human intervention.

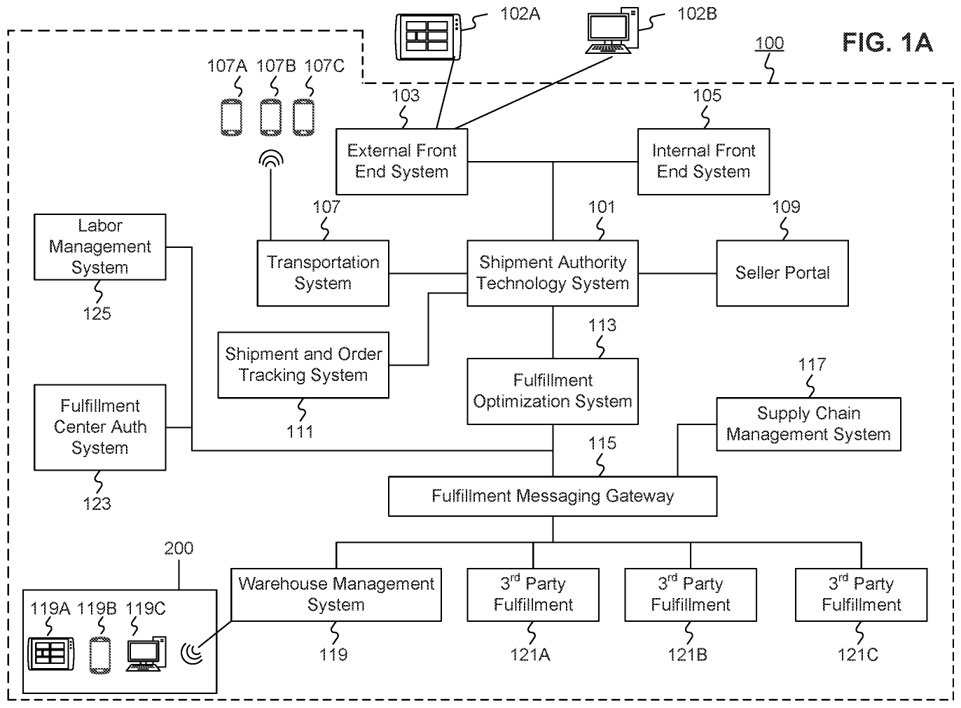

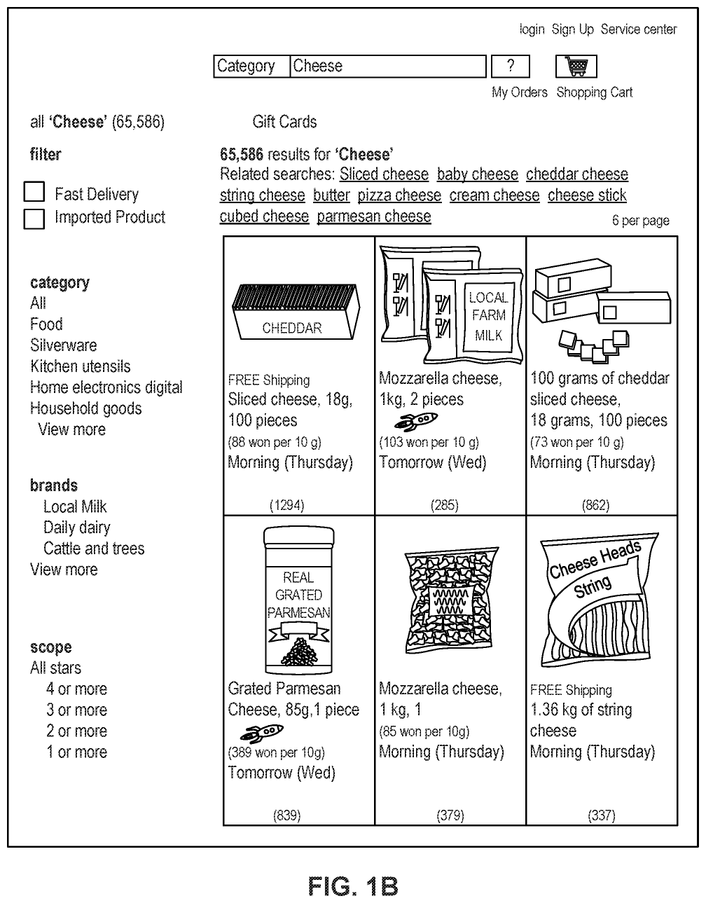

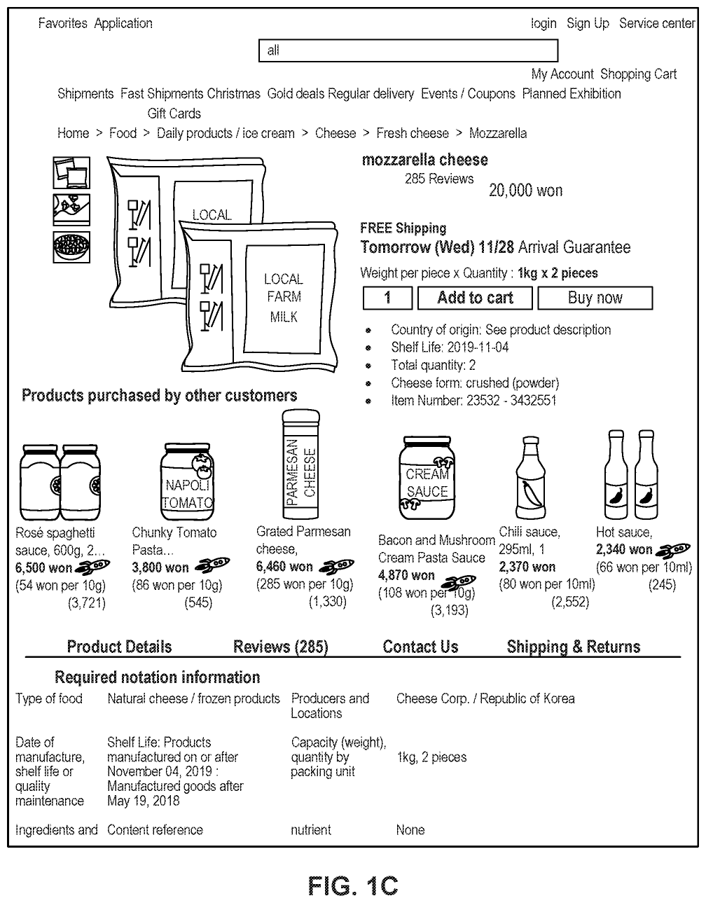

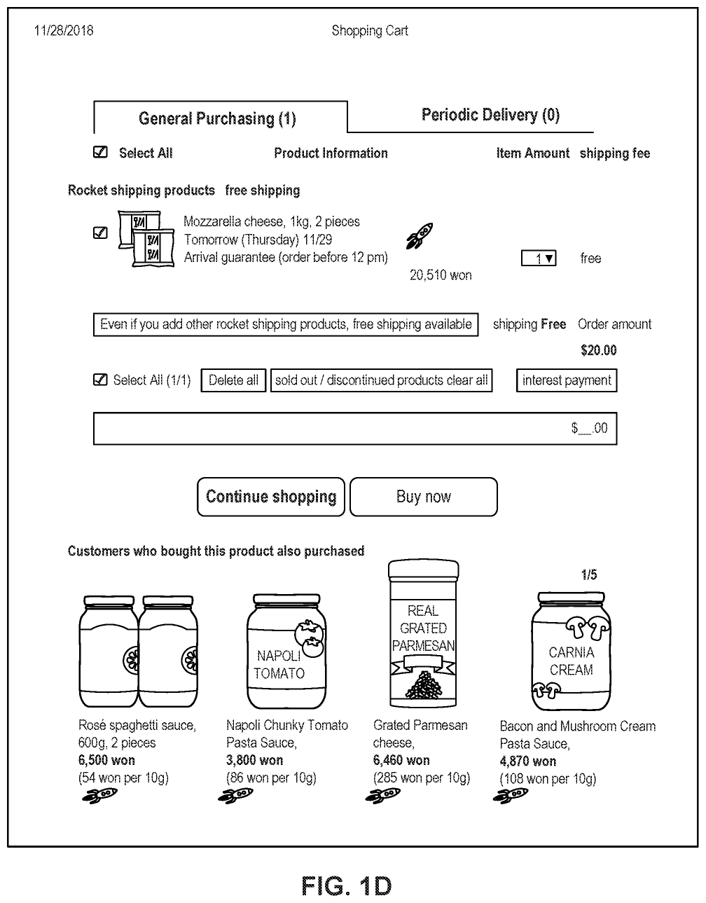

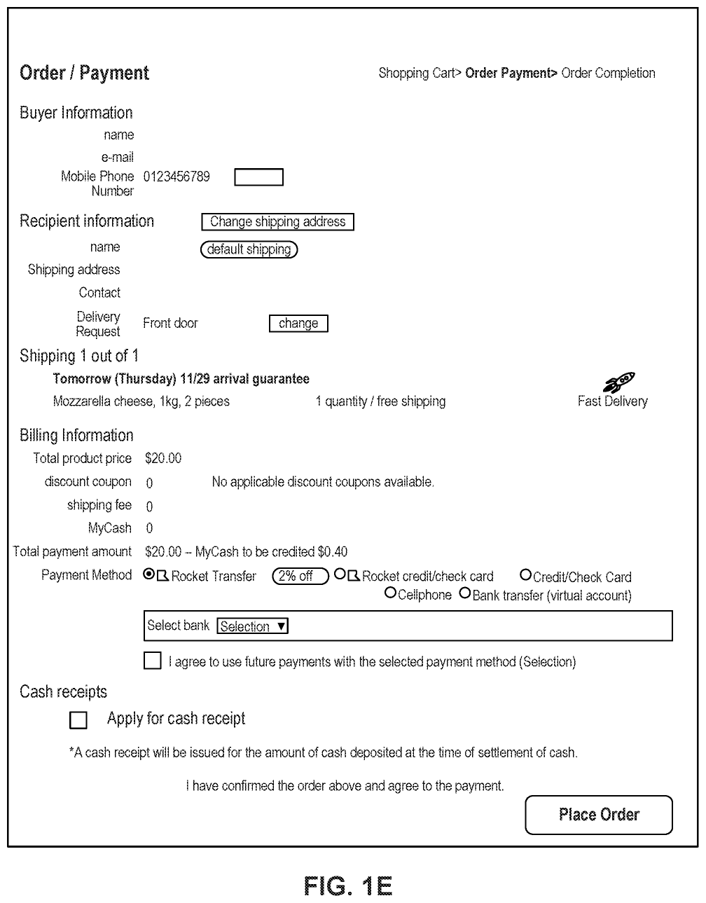

Referring to FIG. 1A, a schematic block diagram 100 illustrating an exemplary embodiment of a system comprising computerized systems for communications enabling shipping, transportation, and logistics operations is shown. As illustrated in FIG. 1A, system 100 may include a variety of systems, each of which may be connected to one another via one or more networks. The systems may also be connected to one another via a direct connection, for example, using a cable. The depicted systems include a shipment authority technology (SAT) system 101, an external front end system 103, an internal front end system 105, a transportation system 107, mobile devices 107A, 107B, and 107C, seller portal 109, shipment and order tracking (SOT) system 111, fulfillment optimization (FO) system 113, fulfillment messaging gateway (FMG) 115, supply chain management (SCM) system 117, warehouse management system 119, mobile devices 119A, 119B, and 119C (depicted as being inside of fulfillment center (FC) 200), 3^{rd} party fulfillment systems 121A, 121B, and 121C, fulfillment center authorization system (FC Auth) 123, and labor management system (LMS) 125.

SAT system 101, in some embodiments, may be implemented as a computer system that monitors order status and delivery status. For example, SAT system 101 may determine whether an order is past its Promised Delivery Date (PDD) and may take appropriate action, including initiating a new order, reshipping the items in the non-delivered order, canceling the non-delivered order, initiating contact with the ordering customer, or the like. SAT system 101 may also monitor other data, including output (such as a number of packages shipped during a particular time period) and input (such as the number of empty cardboard boxes received for use in shipping). SAT system 101 may also act as a gateway between different devices in system 100, enabling communication (e.g., using store-and-forward or other techniques) between devices such as external front end system 103 and FO system 113.

External front end system 103, in some embodiments, may be implemented as a computer system that enables external users to interact with one or more systems in system 100. For example, in embodiments where system 100 enables the presentation of systems to enable users to place an order for an item, external front end system 103 may be implemented as a web server that receives search requests, presents item pages, and solicits payment information. For example, external front end system 103 may be implemented as a computer or computers running software such as the Apache HTTP Server, Microsoft Internet Information Services (IIS), NGINX, or the like. In other embodiments, external front end system 103 may run custom web server software designed to receive and process requests from external devices (e.g., mobile device 102A or computer 102B), acquire information from databases and other data stores based on those requests, and provide responses to the received requests based on acquired information.

In some embodiments, external front end system 103 may include one or more of a web caching system, a database, a search system, or a payment system. In one aspect, external front end system 103 may comprise one or more of these systems, while in another aspect, external front end system 103 may comprise interfaces (e.g., server-to-server, database-to-database, or other network connections) connected to one or more of these systems.

An illustrative set of steps, illustrated by FIGS. 1B, 1C, 1D, and 1E, will help to describe some operations of external front end system 103. External front end system 103 may receive information from systems or devices in system 100 for presentation and/or display. For example, external front end system 103 may host or provide one or more web pages, including a Search Result Page (SRP) (e.g., FIG. 1B), a Single Detail Page (SDP) (e.g., FIG. 1C), a Cart page (e.g., FIG. 1D), or an Order page (e.g., FIG. 1E). A user device (e.g., using mobile device 102A or computer 102B) may navigate to external front end system 103 and request a search by entering information into a search box. External front end system 103 may request information from one or more systems in system 100. For example, external front end system 103 may request information from FO System 113 that satisfies the search request. External front end system 103 may also request and receive (from FO System 113) a Promised Delivery Date or “PDD” for each product included in the search results. The PDD, in some embodiments, may represent an estimate of when a package containing the product will arrive at the user's desired location or a date by which the product is promised to be delivered at the user's desired location if ordered within a particular period of time, for example, by the end of the day (11:59 PM). (PDD is discussed further below with respect to FO System 113.)

External front end system 103 may prepare an SRP (e.g., FIG. 1B) based on the information. The SRP may include information that satisfies the search request. For example, this may include pictures of products that satisfy the search request. The SRP may also include respective prices for each product, or information relating to enhanced delivery options for each product, PDD, weight, size, offers, discounts, or the like. External front end system 103 may send the SRP to the requesting user device (e.g., via a network).

A user device may then select a product from the SRP, e.g., by clicking or tapping a user interface, or using another input device, to select a product represented on the SRP. The user device may formulate a request for information on the selected product and send it to external front end system 103. In response, external front end system 103 may request information related to the selected product. For example, the information may include additional information beyond that presented for a product on the respective SRP. This could include, for example, shelf life, country of origin, weight, size, number of items in package, handling instructions, or other information about the product. The information could also include recommendations for similar products (based on, for example, big data and/or machine learning analysis of customers who bought this product and at least one other product), answers to frequently asked questions, reviews from customers, manufacturer information, pictures, or the like.

External front end system 103 may prepare an SDP (Single Detail Page) (e.g., FIG. 1C) based on the received product information. The SDP may also include other interactive elements such as a “Buy Now” button, a “Add to Cart” button, a quantity field, a picture of the item, or the like. The SDP may further include a list of sellers that offer the product. The list may be ordered based on the price each seller offers such that the seller that offers to sell the product at the lowest price may be listed at the top. The list may also be ordered based on the seller ranking such that the highest ranked seller may be listed at the top. The seller ranking may be formulated based on multiple factors, including, for example, the seller's past track record of meeting a promised PDD. External front end system 103 may deliver the SDP to the requesting user device (e.g., via a network).

The requesting user device may receive the SDP which lists the product information. Upon receiving the SDP, the user device may then interact with the SDP. For example, a user of the requesting user device may click or otherwise interact with a “Place in Cart” button on the SDP. This adds the product to a shopping cart associated with the user. The user device may transmit this request to add the product to the shopping cart to external front end system 103.

External front end system 103 may generate a Cart page (e.g., FIG. 1D). The Cart page, in some embodiments, lists the products that the user has added to a virtual “shopping cart.” A user device may request the Cart page by clicking on or otherwise interacting with an icon on the SRP, SDP, or other pages. The Cart page may, in some embodiments, list all products that the user has added to the shopping cart, as well as information about the products in the cart such as a quantity of each product, a price for each product per item, a price for each product based on an associated quantity, information regarding PDD, a delivery method, a shipping cost, user interface elements for modifying the products in the shopping cart (e.g., deletion or modification of a quantity), options for ordering other product or setting up periodic delivery of products, options for setting up interest payments, user interface elements for proceeding to purchase, or the like. A user at a user device may click on or otherwise interact with a user interface element (e.g., a button that reads “Buy Now”) to initiate the purchase of the product in the shopping cart. Upon doing so, the user device may transmit this request to initiate the purchase to external front end system 103.

External front end system 103 may generate an Order page (e.g., FIG. 1E) in response to receiving the request to initiate a purchase. The Order page, in some embodiments, re-lists the items from the shopping cart and requests input of payment and shipping information. For example, the Order page may include a section requesting information about the purchaser of the items in the shopping cart (e.g., name, address, e-mail address, phone number), information about the recipient (e.g., name, address, phone number, delivery information), shipping information (e.g., speed/method of delivery and/or pickup), payment information (e.g., credit card, bank transfer, check, stored credit), user interface elements to request a cash receipt (e.g., for tax purposes), or the like. External front end system 103 may send the Order page to the user device.

The user device may enter information on the Order page and click or otherwise interact with a user interface element that sends the information to external front end system 103. From there, external front end system 103 may send the information to different systems in system 100 to enable the creation and processing of a new order with the products in the shopping cart.

In some embodiments, external front end system 103 may be further configured to enable sellers to transmit and receive information relating to orders.

Internal front end system 105, in some embodiments, may be implemented as a computer system that enables internal users (e.g., employees of an organization that owns, operates, or leases system 100) to interact with one or more systems in system 100. For example, in embodiments where system 100 enables the presentation of systems to enable users to place an order for an item, internal front end system 105 may be implemented as a web server that enables internal users to view diagnostic and statistical information about orders, modify item information, or review statistics relating to orders. For example, internal front end system 105 may be implemented as a computer or computers running software such as the Apache HTTP Server, Microsoft Internet Information Services (IIS), NGINX, or the like. In other embodiments, internal front end system 105 may run custom web server software designed to receive and process requests from systems or devices depicted in system 100 (as well as other devices not depicted), acquire information from databases and other data stores based on those requests, and provide responses to the received requests based on acquired information.

In some embodiments, internal front end system 105 may include one or more of a web caching system, a database, a search system, a payment system, an analytics system, an order monitoring system, or the like. In one aspect, internal front end system 105 may comprise one or more of these systems, while in another aspect, internal front end system 105 may comprise interfaces (e.g., server-to-server, database-to-database, or other network connections) connected to one or more of these systems.

Transportation system 107, in some embodiments, may be implemented as a computer system that enables communication between systems or devices in system 100 and mobile devices 107A-107C. Transportation system 107, in some embodiments, may receive information from one or more mobile devices 107A-107C (e.g., mobile phones, smart phones, PDAs, or the like). For example, in some embodiments, mobile devices 107A-107C may comprise devices operated by delivery workers. The delivery workers, who may be permanent, temporary, or shift employees, may utilize mobile devices 107A-107C to effect delivery of packages containing the products ordered by users. For example, to deliver a package, the delivery worker may receive a notification on a mobile device indicating which package to deliver and where to deliver it. Upon arriving at the delivery location, the delivery worker may locate the package (e.g., in the back of a truck or in a crate of packages), scan or otherwise capture data associated with an identifier on the package (e.g., a barcode, an image, a text string, an RFID tag, or the like) using the mobile device, and deliver the package (e.g., by leaving it at a front door, leaving it with a security guard, handing it to the recipient, or the like). In some embodiments, the delivery worker may capture photo(s) of the package and/or may obtain a signature using the mobile device. The mobile device may send information to transportation system 107 including information about the delivery, including, for example, time, date, GPS location, photo(s), an identifier associated with the delivery worker, an identifier associated with the mobile device, or the like. Transportation system 107 may store this information in a database (not pictured) for access by other systems in system 100. Transportation system 107 may, in some embodiments, use this information to prepare and send tracking data to other systems indicating the location of a particular package.

In some embodiments, certain users may use one kind of mobile device (e.g., permanent workers may use a specialized PDA with custom hardware such as a barcode scanner, stylus, and other devices) while other users may use other kinds of mobile devices (e.g., temporary or shift workers may utilize off-the-shelf mobile phones and/or smartphones).

In some embodiments, transportation system 107 may associate a user with each device. For example, transportation system 107 may store an association between a user (represented by, e.g., a user identifier, an employee identifier, or a phone number) and a mobile device (represented by, e.g., an International Mobile Equipment Identity (IMEI), an International Mobile Subscription Identifier (IMSI), a phone number, a Universal Unique Identifier (UUID), or a Globally Unique Identifier (GUID)). Transportation system 107 may use this association in conjunction with data received on deliveries to analyze data stored in the database in order to determine, among other things, a location of the worker, an efficiency of the worker, or a speed of the worker.

Seller portal 109, in some embodiments, may be implemented as a computer system that enables sellers or other external entities to electronically communicate with one or more systems in system 100. For example, a seller may utilize a computer system (not pictured) to upload or provide product information, order information, contact information, or the like, for products that the seller wishes to sell through system 100 using seller portal 109.

Shipment and order tracking system 111, in some embodiments, may be implemented as a computer system that receives, stores, and forwards information regarding the location of packages containing products ordered by customers (e.g., by a user using devices 102A-102B). In some embodiments, shipment and order tracking system 111 may request or store information from web servers (not pictured) operated by shipping companies that deliver packages containing products ordered by customers.

In some embodiments, shipment and order tracking system 111 may request and store information from systems depicted in system 100. For example, shipment and order tracking system 111 may request information from transportation system 107. As discussed above, transportation system 107 may receive information from one or more mobile devices 107A-107C (e.g., mobile phones, smart phones, PDAs, or the like) that are associated with one or more of a user (e.g., a delivery worker) or a vehicle (e.g., a delivery truck). In some embodiments, shipment and order tracking system 111 may also request information from warehouse management system (WMS) 119 to determine the location of individual products inside of a fulfillment center (e.g., fulfillment center 200). Shipment and order tracking system 111 may request data from one or more of transportation system 107 or WMS 119, process it, and present it to a device (e.g., user devices 102A and 102B) upon request.

Fulfillment optimization (FO) system 113, in some embodiments, may be implemented as a computer system that stores information for customer orders from other systems (e.g., external front end system 103 and/or shipment and order tracking system 111). FO system 113 may also store information describing where particular items are held or stored. For example, certain items may be stored only in one fulfillment center, while certain other items may be stored in multiple fulfillment centers. In still other embodiments, certain fulfilment centers may be designed to store only a particular set of items (e.g., fresh produce or frozen products). FO system 113 stores this information as well as associated information (e.g., quantity, size, date of receipt, expiration date, etc.).

FO system 113 may also calculate a corresponding PDD (promised delivery date) for each product. The PDD, in some embodiments, may be based on one or more factors. For example, FO system 113 may calculate a PDD for a product based on a past demand for a product (e.g., how many times that product was ordered during a period of time), an expected demand for a product (e.g., how many customers are forecast to order the product during an upcoming period of time), a network-wide past demand indicating how many products were ordered during a period of time, a network-wide expected demand indicating how many products are expected to be ordered during an upcoming period of time, one or more counts of the product stored in each fulfillment center 200, which fulfillment center stores each product, expected or current orders for that product, or the like.

In some embodiments, FO system 113 may determine a PDD for each product on a periodic basis (e.g., hourly) and store it in a database for retrieval or sending to other systems (e.g., external front end system 103, SAT system 101, shipment and order tracking system 111). In other embodiments, FO system 113 may receive electronic requests from one or more systems (e.g., external front end system 103, SAT system 101, shipment and order tracking system 111) and calculate the PDD on demand.

Fulfilment messaging gateway (FMG) 115, in some embodiments, may be implemented as a computer system that receives a request or response in one format or protocol from one or more systems in system 100, such as FO system 113, converts it to another format or protocol, and forward it in the converted format or protocol to other systems, such as WMS 119 or 3^{rd} party fulfillment systems 121A, 121B, or 121C, and vice versa.

Supply chain management (SCM) system 117, in some embodiments, may be implemented as a computer system that performs forecasting functions. For example, SCM system 117 may forecast a level of demand for a particular product based on, for example, based on a past demand for products, an expected demand for a product, a network-wide past demand, a network-wide expected demand, a count products stored in each fulfillment center 200, expected or current orders for each product, or the like. In response to this forecasted level and the amount of each product across all fulfillment centers, SCM system 117 may generate one or more purchase orders to purchase and stock a sufficient quantity to satisfy the forecasted demand for a particular product.

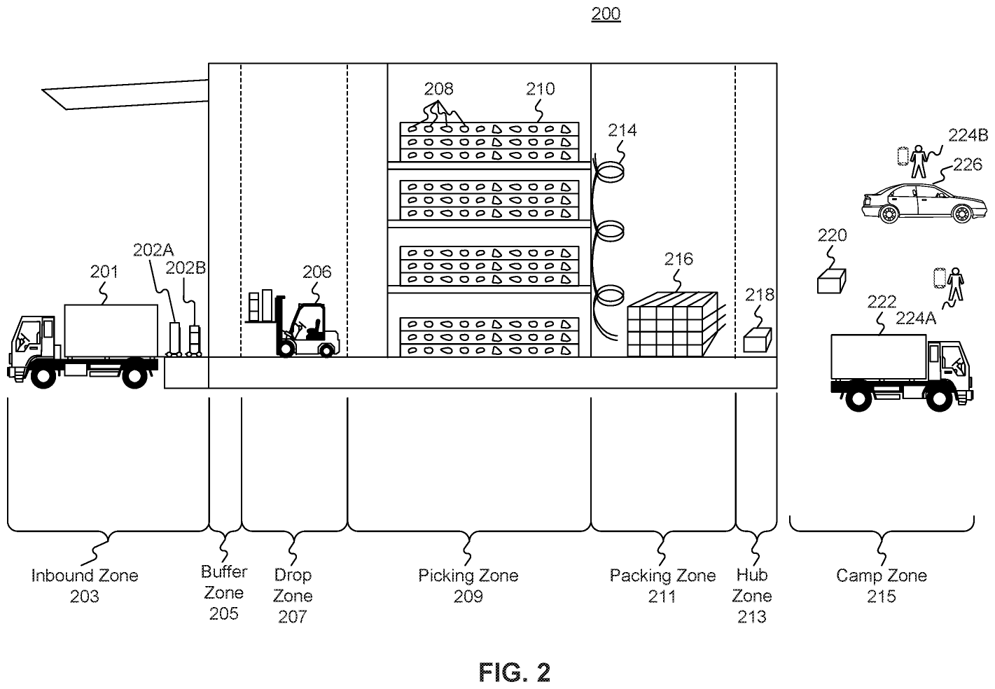

Warehouse management system (WMS) 119, in some embodiments, may be implemented as a computer system that monitors workflow. For example, WMS 119 may receive event data from individual devices (e.g., devices 107A-107C or 119A-119C) indicating discrete events. For example, WMS 119 may receive event data indicating the use of one of these devices to scan a package. As discussed below with respect to fulfillment center 200 and FIG. 2, during the fulfillment process, a package identifier (e.g., a barcode or RFID tag data) may be scanned or read by machines at particular stages (e.g., automated or handheld barcode scanners, RFID readers, high-speed cameras, devices such as tablet 119A, mobile device/PDA 1198, computer 119C, or the like). WMS 119 may store each event indicating a scan or a read of a package identifier in a corresponding database (not pictured) along with the package identifier, a time, date, location, user identifier, or other information, and may provide this information to other systems (e.g., shipment and order tracking system 111).

WMS 119, in some embodiments, may store information associating one or more devices (e.g., devices 107A-107C or 119A-119C) with one or more users associated with system 100. For example, in some situations, a user (such as a part- or full-time employee) may be associated with a mobile device in that the user owns the mobile device (e.g., the mobile device is a smartphone). In other situations, a user may be associated with a mobile device in that the user is temporarily in custody of the mobile device (e.g., the user checked the mobile device out at the start of the day, will use it during the day, and will return it at the end of the day).

WMS 119, in some embodiments, may maintain a work log for each user associated with system 100. For example, WMS 119 may store information associated with each employee, including any assigned processes (e.g., unloading trucks, picking items from a pick zone, rebin wall work, packing items), a user identifier, a location (e.g., a floor or zone in a fulfillment center 200), a number of units moved through the system by the employee (e.g., number of items picked, number of items packed), an identifier associated with a device (e.g., devices 119A-119C), or the like. In some embodiments, WMS 119 may receive check-in and check-out information from a timekeeping system, such as a timekeeping system operated on a device 119A-119C.

3^{rd} party fulfillment (3PL) systems 121A-121C, in some embodiments, represent computer systems associated with third-party providers of logistics and products. For example, while some products are stored in fulfillment center 200 (as discussed below with respect to FIG. 2), other products may be stored off-site, may be produced on demand, or may be otherwise unavailable for storage in fulfillment center 200. 3PL systems 121A-121C may be configured to receive orders from FO system 113 (e.g., through FMG 115) and may provide products and/or services (e.g., delivery or installation) to customers directly. In some embodiments, one or more of 3PL systems 121A-121C may be part of system 100, while in other embodiments, one or more of 3PL systems 121A-121C may be outside of system 100 (e.g., owned or operated by a third-party provider).

Fulfillment Center Auth system (FC Auth) 123, in some embodiments, may be implemented as a computer system with a variety of functions. For example, in some embodiments, FC Auth 123 may act as a single-sign on (SSO) service for one or more other systems in system 100. For example, FC Auth 123 may enable a user to log in via internal front end system 105, determine that the user has similar privileges to access resources at shipment and order tracking system 111, and enable the user to access those privileges without requiring a second log in process. FC Auth 123, in other embodiments, may enable users (e.g., employees) to associate themselves with a particular task. For example, some employees may not have an electronic device (such as devices 119A-119C) and may instead move from task to task, and zone to zone, within a fulfillment center 200, during the course of a day. FC Auth 123 may be configured to enable those employees to indicate what task they are performing and what zone they are in at different times of day.

Labor management system (LMS) 125, in some embodiments, may be implemented as a computer system that stores attendance and overtime information for employees (including full-time and part-time employees). For example, LMS 125 may receive information from FC Auth 123, WMS 119, devices 119A-119C, transportation system 107, and/or devices 107A-107C.

The particular configuration depicted in FIG. 1A is an example only. For example, while FIG. 1A depicts FC Auth system 123 connected to FO system 113, not all embodiments require this particular configuration. Indeed, in some embodiments, the systems in system 100 may be connected to one another through one or more public or private networks, including the Internet, an Intranet, a WAN (Wide-Area Network), a MAN (Metropolitan-Area Network), a wireless network compliant with the IEEE 802.11a/b/g/n Standards, a leased line, or the like. In some embodiments, one or more of the systems in system 100 may be implemented as one or more virtual servers implemented at a data center, server farm, or the like.

FIG. 2 depicts a fulfillment center 200. Fulfillment center 200 is an example of a physical location that stores items for shipping to customers when ordered. Fulfillment center (FC) 200 may be divided into multiple zones, each of which are depicted in FIG. 2. These “zones,” in some embodiments, may be thought of as virtual divisions between different stages of a process of receiving items, storing the items, retrieving the items, and shipping the items. So while the “zones” are depicted in FIG. 2, other divisions of zones are possible, and the zones in FIG. 2 may be omitted, duplicated, or modified in some embodiments.

Inbound zone 203 represents an area of FC 200 where items are received from sellers who wish to sell products using system 100 from FIG. 1A. For example, a seller may deliver items 202A and 202B using truck 201. Item 202A may represent a single item large enough to occupy its own shipping pallet, while item 202B may represent a set of items that are stacked together on the same pallet to save space.

A worker will receive the items in inbound zone 203 and may optionally check the items for damage and correctness using a computer system (not pictured). For example, the worker may use a computer system to compare the quantity of items 202A and 202B to an ordered quantity of items. If the quantity does not match, that worker may refuse one or more of items 202A or 2026. If the quantity does match, the worker may move those items (using, e.g., a dolly, a handtruck, a forklift, or manually) to buffer zone 205. Buffer zone 205 may be a temporary storage area for items that are not currently needed in the picking zone, for example, because there is a high enough quantity of that item in the picking zone to satisfy forecasted demand. In some embodiments, forklifts 206 operate to move items around buffer zone 205 and between inbound zone 203 and drop zone 207. If there is a need for items 202A or 202B in the picking zone (e.g., because of forecasted demand), a forklift may move items 202A or 202B to drop zone 207.

Drop zone 207 may be an area of FC 200 that stores items before they are moved to picking zone 209. A worker assigned to the picking task (a “picker”) may approach items 202A and 202B in the picking zone, scan a barcode for the picking zone, and scan barcodes associated with items 202A and 202B using a mobile device (e.g., device 119B). The picker may then take the item to picking zone 209 (e.g., by placing it on a cart or carrying it).

Picking zone 209 may be an area of FC 200 where items 208 are stored on storage units 210. In some embodiments, storage units 210 may comprise one or more of physical shelving, bookshelves, boxes, totes, refrigerators, freezers, cold stores, or the like. In some embodiments, picking zone 209 may be organized into multiple floors. In some embodiments, workers or machines may move items into picking zone 209 in multiple ways, including, for example, a forklift, an elevator, a conveyor belt, a cart, a handtruck, a dolly, an automated robot or device, or manually. For example, a picker may place items 202A and 202B on a handtruck or cart in drop zone 207 and walk items 202A and 202B to picking zone 209.

A picker may receive an instruction to place (or “stow”) the items in particular spots in picking zone 209, such as a particular space on a storage unit 210. For example, a picker may scan item 202A using a mobile device (e.g., device 119B). The device may indicate where the picker should stow item 202A, for example, using a system that indicate an aisle, shelf, and location. The device may then prompt the picker to scan a barcode at that location before stowing item 202A in that location. The device may send (e.g., via a wireless network) data to a computer system such as WMS 119 in FIG. 1A indicating that item 202A has been stowed at the location by the user using device 1196.

Once a user places an order, a picker may receive an instruction on device 119B to retrieve one or more items 208 from storage unit 210. The picker may retrieve item 208, scan a barcode on item 208, and place it on transport mechanism 214. While transport mechanism 214 is represented as a slide, in some embodiments, transport mechanism may be implemented as one or more of a conveyor belt, an elevator, a cart, a forklift, a handtruck, a dolly, a cart, or the like. Item 208 may then arrive at packing zone 211.

Packing zone 211 may be an area of FC 200 where items are received from picking zone 209 and packed into boxes or bags for eventual shipping to customers. In packing zone 211, a worker assigned to receiving items (a “rebin worker”) will receive item 208 from picking zone 209 and determine what order it corresponds to. For example, the rebin worker may use a device, such as computer 119C, to scan a barcode on item 208. Computer 119C may indicate visually which order item 208 is associated with. This may include, for example, a space or “cell” on a wall 216 that corresponds to an order. Once the order is complete (e.g., because the cell contains all items for the order), the rebin worker may indicate to a packing worker (or “packer”) that the order is complete. The packer may retrieve the items from the cell and place them in a box or bag for shipping. The packer may then send the box or bag to a hub zone 213, e.g., via forklift, cart, dolly, handtruck, conveyor belt, manually, or otherwise.

Hub zone 213 may be an area of FC 200 that receives all boxes or bags (“packages”) from packing zone 211. Workers and/or machines in hub zone 213 may retrieve package 218 and determine which portion of a delivery area each package is intended to go to, and route the package to an appropriate camp zone 215. For example, if the delivery area has two smaller sub-areas, packages will go to one of two camp zones 215. In some embodiments, a worker or machine may scan a package (e.g., using one of devices 119A-119C) to determine its eventual destination. Routing the package to camp zone 215 may comprise, for example, determining a portion of a geographical area that the package is destined for (e.g., based on a postal code) and determining a camp zone 215 associated with the portion of the geographical area.

Camp zone 215, in some embodiments, may comprise one or more buildings, one or more physical spaces, or one or more areas, where packages are received from hub zone 213 for sorting into routes and/or sub-routes. In some embodiments, camp zone 215 is physically separate from FC 200 while in other embodiments camp zone 215 may form a part of FC 200.

Workers and/or machines in camp zone 215 may determine which route and/or sub-route a package 220 should be associated with, for example, based on a comparison of the destination to an existing route and/or sub-route, a calculation of workload for each route and/or sub-route, the time of day, a shipping method, the cost to ship the package 220, a PDD associated with the items in package 220, or the like. In some embodiments, a worker or machine may scan a package (e.g., using one of devices 119A-119C) to determine its eventual destination. Once package 220 is assigned to a particular route and/or sub-route, a worker and/or machine may move package 220 to be shipped. In exemplary FIG. 2, camp zone 215 includes a truck 222, a car 226, and delivery workers 224A and 224B. In some embodiments, truck 222 may be driven by delivery worker 224A, where delivery worker 224A is a full-time employee that delivers packages for FC 200 and truck 222 is owned, leased, or operated by the same company that owns, leases, or operates FC 200. In some embodiments, car 226 may be driven by delivery worker 224B, where delivery worker 224B is a “flex” or occasional worker that is delivering on an as-needed basis (e.g., seasonally). Car 226 may be owned, leased, or operated by delivery worker 224B.

According to some embodiments, there is provided a method for filtering products based on images. As described previously, products may be associated with product information, which may include images or pictures. An image, as used here, may be a visual representation of a product, its features, use, and/or other properties. Examples of an image include drawing, picture, photo, graphic, animation, cartoon, illustration, icon, and/or other visual elements. In some embodiments, the method may be executed by a computer system including memory storage media and one or more processors. For example, the computer system may be system 100 depicted FIG. 1A.

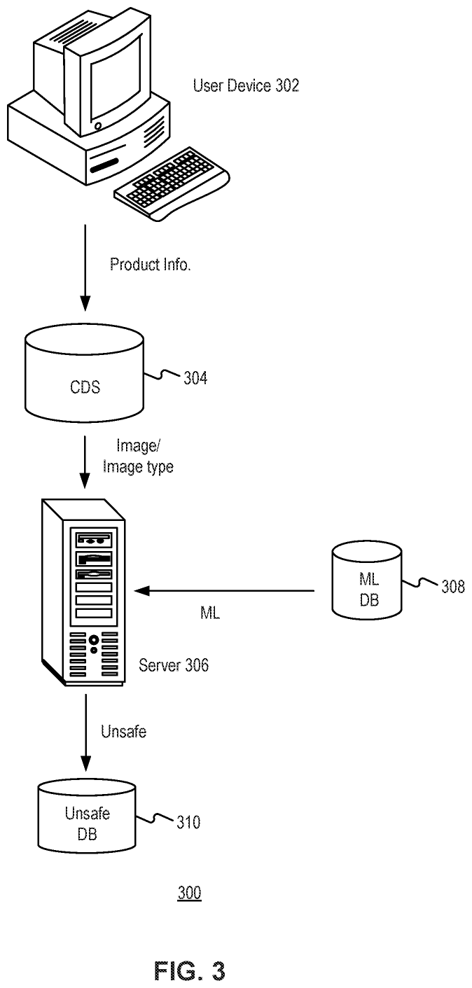

By way of another example, FIG. 3 depicts a schematic illustration of an exemplary computerized system, including user device 302, CDS 304, server 306, ML DB 308, and unsafe DB 310. One or more components of system 300 may be connected by a network. User device 302 may be devices configured for interaction with users, such as devices 102A-B depicted in FIG. 1A. Users may include shoppers, browsers, vendors, seller, and other parties who interact with external front end system 103. Server 306 may represent system 100, or one or more of the subsystems of system 100. CDS 304, ML DB 308, and unsafe DB 310 may be examples of the one or more memory storage media. In some embodiments, CDS 304, ML DB 308, and unsafe DB 310 may be different portions of a single storage media configured to store different information.

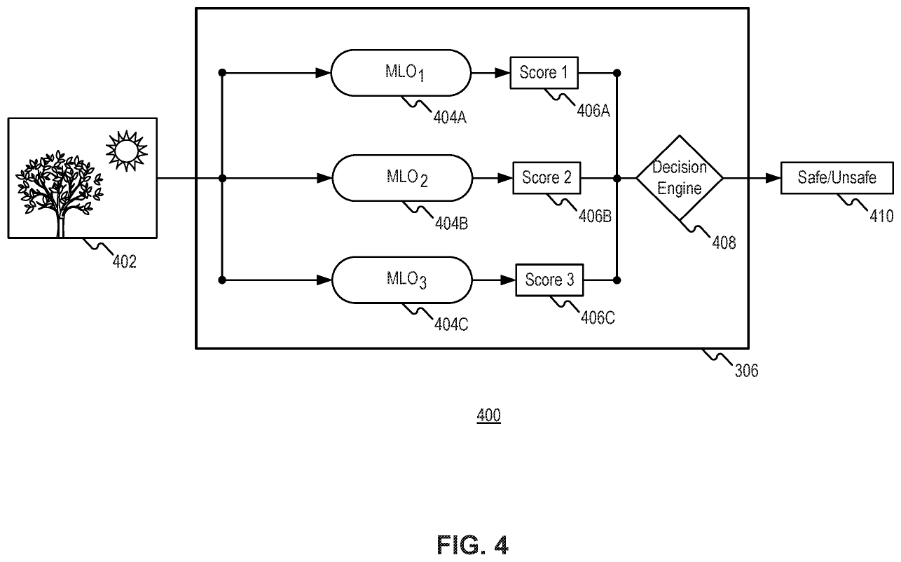

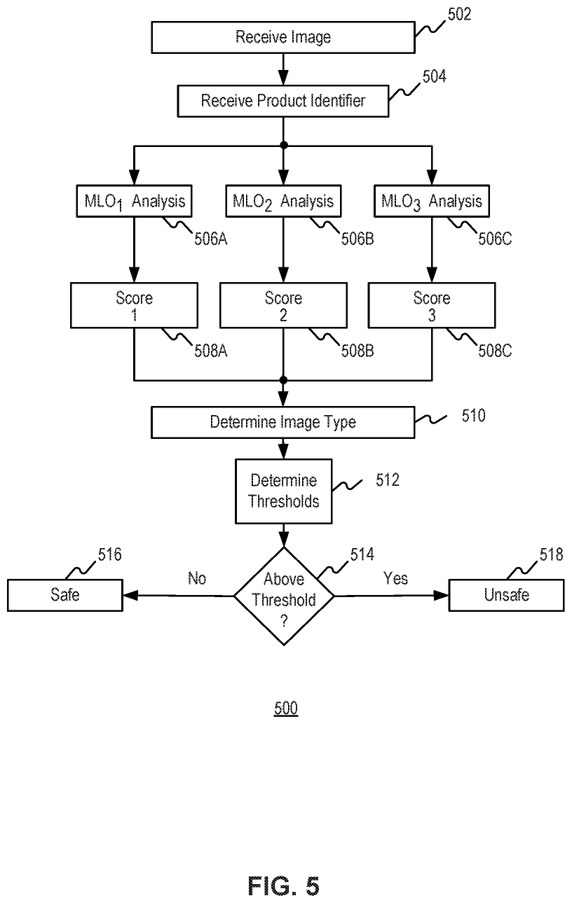

FIG. 4 is a diagrammatic illustration of an exemplary machine learning architecture for filtering products associated with unsafe images, consistent with the disclosed embodiments. In some embodiments, the architecture depicted in FIG. 4 may be implemented in server 306. By way of example, server 306 may receive image 402 from one or more database, such as CDS 304. One or more machine learning models, such as 404A-C may each perform analysis of image 402, and generate scores 406A-C respectively. Based on scores 406 A-C, decision engine 408 may determine whether image 402 is safe or unsafe, and whether to assign a sensitive status accordingly. Detailed operations of server 306 will now be described below with reference to process 500 depicted in FIG. 5.

The method for filtering products based on images includes receiving image data representing an image, the image being associated with a product identifier. By way of example, FIG. 5 depicts an exemplary flowchart of the method for filtering products based on images.

In step 502, server 306 receives an image. In the context of computer technology, the image is represented by image data. An image may be digitized into image data for processing and manipulation by computer systems. The image data may be data bits, such as binary bits. The image data may be stored and transmitted in files such as JPEG, TIFF, GIF, BMP, PNG, BAT, and other similar image files formats.

In step 504, server 306 receives a product identifier. A product identifier may be data that uniquely identifies a product stored in a database. For example, a product identifier may include serial number, tag, stock keeping unit, name, code, and/or other identifying information. Various different information relating to the same product may be linked via the product identifier when stored in the database.

In some embodiments, in steps 502 and 504, server 306 receives information uploaded to a database, the information containing at least the product identifier and one or more images associated with the product identifier. By way of example, as depicted in FIG. 3, users may upload information relating to a product to CDS 304. Information may include information about or relating to a product, such as images of the product, as well as name, quantity, price, size, weight, brand, color, and/or other relevant data of the product. In some embodiments, as part of the uploading process, a product identifier is assigned to the product such that all information relating to the same product are linked when stored in CDS 304. In steps 502 and 504, server 306 may receive the product identifier and one or more images associated with the product identifier by retrieval from CDS 304. According some embodiments, the method further includes analyzing the image data by a plurality of machine learning models. Machine learning models may refer to computer software, programs and/or algorithms that are capable of carrying out tasks without specifically being instructed or programmed to do so. Examples of machine learning models include neural networks, decision trees, regression analysis, Bayesian networks, genetic algorithms, and/or other models configured to train on some training data, and is configured by the training to process additional data to make predictions or decisions. By way of example, server 306 analyzes the image data using a plurality of machine learning models in steps 506 A-C. In some embodiments, the plurality of machine learning models may be computer codes and programs stored in a storage media, such as ML DB 308, and server 306 may retrieve the plurality of machine learning models from ML DB 308 during step 506 A-C.

In some embodiments, the plurality of machine learning models includes at least a neural network image classifier configured to detect nudity. Neural network, or artificial neural network, may refer to a type of machine learning model which input data are provided to layers of networked nodes, which in turn provide output data. Within the layers, the networked nodes are connected via network connections which are ‘weighted.” Input data may be processed by one or more of these networked nodes, passing through these weighted connections. The weights of the weighted connections may be determined by a learning rule. A learning rule may be a logic for assigning a weight to each of the connection of a networked node. For example, the learning rule may be relations contained in a set of training data including pre-labeled input and output data. A neural network may thus be “trained” to recognize the relationship between pre-labeled input and output data by to assigning weights to the connections between the networked nodes in the layers. Once trained, using the established weighted connections between the networked nodes, the neural network may process additional input data to produce desired output data.

In some embodiments, the plurality of machine learning models further includes at least a convolutional neural network configured to detect objects. A convolutional neural network may refer to a type of neural network in which each of the layers of nodes may be configured to recognize a specific feature of an input, and multiple layers of nodes work together to produce an output. In a convolutional neural network, data may pass from one layer to the next layer through a sliding dot product operation between the layers. Examples of convolutional neural networks may include LeNet, MobileNet, AlexNet, VGGNet, GoogLeNet, ResNet, ZFNet, Xception, EfficientNet, and other similar neural network machine learning models. In some embodiments, when applied in image analysis, a convolutional neural network may have different layers to capture different details from the input image, such edges or colors. As used herein, objects may refer to things, texts, animals, people, or parts of things, animals or people that may appear on an image.

In some embodiments, the neural network may be utilized by an image classifier. An image classifier may refer to programs, algorithms, logics, or codes for determining one or more aspect or attribute of an image. The image classifier may assign to an image one or more classes, a class being a pre-defined property of the image. Using a trained neural network, the image classifier may attempt recognize some features of an image, and assign a class to the image based on the output of the neural network. The neural network image classifier may classify images based on nudity. Nudity, as used herein, may refer to content of images depicting human subjects not wearing clothing covering certain body parts, such as genitals. Examples of nudity detection image classifier include NudeNet. NudeNet is a convolutional neural network image classifier which is built by training an Xception model architecture and using sets of Nude/Safe images. The classifier, in some embodiments, has the ability to classify images in two classes: Nude or Safe (i.e., does not contain nudity).

By way of example, in step 506A, server 306 analyzes the received image using machine learning model MLO₁. In some embodiments, MLO₁ may be an example of a neural network image classifier configured to detect nudity. MLO₁ may be configured to identify one or more predefined objects from image 402. The predefined objects may include exposed region of a body, such as face, arm, leg, feet, breast, buttocks, genitalia, and/or other features of human bodies that may indicate nudity. In some embodiments, MLO₁ is pretrained using a plurality of training images. The training images may depict the one or more predefined objects, which are pre-labeled to indicate the presence of the one or more predefined objects. An example of MLO₁ may be NudeNet.

By way of example, in step 506B, server 306 analyzes the received image using machine learning model MLO₂. In some embodiments, MLO₂ may be an example of a convolutional neural network configured to detect objects. In some embodiments, MLO₂ may operate substantially similar to MLO₁, but with optimized neural network architectures. The optimization may be achieved, for example, by relating the different layers of nodes via convolution. In some embodiments, MLO₂ may be configured to analyze images having increased resolutions compared to MLO₁. In some embodiments, MLO₂ may be configured to identify pre-defined objects in images have increased noise and cluttering. Noise and cluttering may refer to properties of an image describing the level or amount of objects depicted in the image. For example, an image depicting many objects spaced closely together is more noisy or cluttered than an image depicting few objects spaced apart. A person of ordinary skill in the art will now appreciate that a nudity detector such as MLO₁ may not be adequate when analyzing images that are noisy or cluttered. Simply scaling MLO₁ for higher performance may be computationally expensive and time consuming, hence MLO₂ may be deployed along with MLO₁ to analyze images not suited for MLO₁.

In some embodiments, the plurality of machine learning models further includes at least a compound scaled convolutional neural network configured to detect objects. A compound scaled convolutional neural network may refer a convolutional neural network modified via a compound scaling method. Generally, as more computation resources are available, a convolutional neural network may be able to perform analysis of larger images, or perform analysis with greater detail. This may be referred to as scaling. In compound scaling, the connections between the networked nodes are scaled by a compound coefficient, such that the overall network relationship is preserved during the scaling. Examples of compound scaled convolutional neural network include EfficientNet.

By way of example, in step 506C, server 306 analyzes the received image using machine learning model MLO₃. In some embodiments, MLO₃ may be an example of a compound scaled convolutional neural network configured to detect objects. In some embodiments, MLO₃ may operate substantially similar to MLO₁ and MLO₂. In some embodiments, MLO₃ may be a further development of MLO₂, configured to allow for more efficient scaling to analyze more abstract images without excessively increasing the computational power required. A person of ordinary skill in the art would now appreciate that the number of different machine learning models deployed in server 306 may be adjusted to achieve the desired balanced between achieving greater accuracy, conservation of computational power, and development time. Developing and deploying a single machine model optimized for all situations or all types of images may be impractical and require excessive computational power, thus it may be more advantageous is deploy a number of machine learning models to achieve the desired balance.

In some embodiments, MLO₂ and MLO₃ may be constructed from models trained in particular methods. For example, MLO₂ and MLO₃ may be constructed using the known MobileNet and EfficientNet models, respectively. For example, MobileNet and EfficientNet are models already trained using sets of training images for general image classification purposes, and may be able to classify input images into more than 1000 classes. Constructing MLO₂ and MLO₃ may include additional fine-tuning processes of MobileNet and EfficientNet, by replacing last layers of MobileNet and EfficientNet with new classifier layers. In some embodiments, the new classifier layers may be trained using set of unsafe/safe images from databases, such as CDS 304, that are pre-labeled. The fine-tuned models (e.g., MLO₂ and MLO₃) constructed based on MobileNet and EfficientNet may thus be sensitive to the unsafe features for images that could be found in CDS 304, and be configured to generate a score based on unsafe probability.

According to some embodiments, the method further includes generating a plurality of image scores for the image, each image score being generated by each of the plurality of machine learning models. An image score may be a numerical value assigned to the image by one of the plurality of machine learning models. In some embodiments, the plurality of image scores includes a first image score, a second image score, and a third image score. For example, each of the image scores may be a numerical value between 0 and 1. The image score may represent a probability that, based on the analysis of the machine learning models, that the image is unsafe. An unsafe image may be an image that depicts subject matter that may create offense when viewed by some individuals. Such offensive subject matter may include nudity, sexual poses and postures, a person dressed only in lingerie or underwear, or similar visual representations of adult themes.

In some embodiments, a first image score is generated by the neural network image classifier. For example, in step 508A, server 306 generates a first score using MLO₁. In some embodiments, a second image score is generated by the convolutional neural network. For example, in step 508B, server 306 generates a second score using MLO₂. In some embodiments, a third image score is generated by the compound scaled convolutional neural network. For example, in step 508C, server 306 generates a third score using MLO₃.

By way of example, as depicted in FIG. 4, image 402 may be an image associated with a product. In step 502, server 306 may receive image 402 from CDS 304.

Server 306 may include 404A, which is an example of a neural network image classifier configured to detect nudity; 404B, which is an example of a convolutional neural network configured to detect objects; and 404C, which is a compound scaled convolutional neural network configured to detect objects. Server 306 utilizes 404A to analyze image 402 in step 506A, and provide as output score 406A. Server 306 utilizes 404B to analyze image in step 506B, and provide as output score 406B. Server 306 utilizes 404C to analyze image 402 in step 506C, and provides as output score 406C.

According to some embodiments, the methods further include determining, based on the plurality of image scores, whether the image has a sensitive status. Sensitive status may refer to a data value assigned to images. For example, sensitive status may be a flag, tag, or Boolean value to be associated with the image when stored in a database, such as unsafe DB 310 or CDS 304. An image may be assigned sensitive status if it is unsafe. In some embodiments, the sensitive status is assigned based on a comparison between a threshold value and scores of the plurality of image scores. A threshold value may refer to numerical value representing a threshold, where there is one condition above the threshold, and a different condition below the threshold.

In some embodiments, the threshold values of the plurality of images depend on an image type of the image. An image type may be a property of the image, and may be indicated by a numerical value associated with the image data. The image type may describe the type imagery, such as whether the image is a painting, photo, graphic art, and/or other manner by which the image may be generated. The image type may also indicate the type product that the image is associated with, such as apparel, toys, books, magazine, appliances, electronics, and/or other product categories. In some embodiments, the numerical value indicating the image type may be generated when the image is uploaded to CDS 304 based on the information of the product associated with the image. For example, CDS 304 may assign predetermined numerical value indicating the image type corresponding to the product or product categories.

In some embodiments, the image type includes at least one of fashion image, book image, and cartoon image. A fashion image may refer to an image that associated with apparel. Such images may include of images depicting a person in various states of being dressed in different clothing. Examples of unsafe images falling into this image type may include images depicting a person wearing lingerie, underwear, or clothing that may be excessively revealing. A book image may refer to an image that is associated with book products, typically but not always the cover art of books. In some instances, books of certain categories, such as erotica or romantic novels, may have cover arts that may be considered to be unsafe. A cartoon image may refer to an image that are in the artistic style of animation, such as comics or manga. The image type may correspond to the associated product information. For example, images associated with an apparel may be stored in CDS 304 as a fashion image; images associated with book may be stored in CDS 304 as book images; and images associated with comics or manga may be stored in CDS 304 as cartoon images.

By way of example, in step 510, server 306 determines an image type of the image. In some embodiments, the image data of the image may include a numerical value indicating the image type of the image. For example, the image data of a fashion image have a numerical value that is different from that of a book image or a cartoon image.

In step 512, server 306 determines threshold values corresponding to the plurality of image scores. based on the image type determined in step 510. Depending on the image type, the plurality of machine learning models may have different levels of efficiency or reliability. By way example, image 402 is analyzed by 404A, 404B, and 404C, with each machine learning model producing an image score for image 402. Due to the underlying differences in neural network architectures and learning rules, scores 406A, 406B, and 406C may be very different each other.

In some embodiments, when image 402 is a fashion image, a nudity detector, such as 404A, may be able to reliably produce scores that differentiates a safe image and an unsafe image. Therefore, threshold value for score 406A should be assigned a lower value, while threshold values for scores 406B and 406C may be assigned very high value. For example, server 306 may determine that the threshold value of score 404A to be 0.5-0.8, and the threshold values scores 406B and 406C to be close to 1, and determine the threshold values accordingly in step 512.

In some embodiments, when image 402 is a book image, a nudity detector, such as 404A, may be less reliable. Therefore, threshold values for scores 406A, 406B, and 406C may be assigned roughly equal value. For example, server 306 may determine that the threshold values of scores 406A, 406B and 406C to be 0.75, and determine the threshold values accordingly in step 512.

In some embodiments, when image 402 is a cartoon image, a convolutional neural network object detector, such as 404B, may be unreliable. Therefore, threshold value for score 406B may be a high value. For example, server 306 may determine that the threshold values for scores 406A and 406C to be 0.7, while the threshold value for score 406B to be close to 1, and determine the threshold values accordingly in step 512. In some embodiments, 404C may also be tuned to work with book images without the use of 404B, and a single threshold value may be used for both book images and cartoon images.

In step 514, server 306 compares the scores to the threshold values. In some embodiments, If each of the scores is greater than the corresponding threshold values associated with the corresponding analysis, step 514 is YES, and process 500 proceeds to step 518. If one of the scores is less than the threshold, step 514 is NO, and process 500 proceeds to step 516.

By way of example, as depicted in FIG. 4, server 306 further includes a decision engine 408 for carrying out steps 510-518. Decision engine 408 may be a software module, such as codes, algorithms, programs or logics, executable by server 306. Decision engine 408 may determine in steps 510 and 512, based on the image type of image 402, values of the first, second, and third factor. Decision engine 408 may also determine threshold values for scores 406A, 406B, and 406C based on the image type of image 402. In step 514, decision engine 408 may compare the scores to the threshold values.

In some embodiments, the scores represent a likelihood that the image is unsafe, and the threshold values may represent a threshold of likelihood, above which the sensitive status may be assigned to the image by decision engine 408. For example, if the threshold value is 0.75, then decision engine will assign images with 75% or greater likelihood of being unsafe the sensitive status. A person of ordinary skill in the art will now appreciate that the threshold value may be adjusted based on design goal. For example, a higher threshold value will increase the likelihood that images having the sensitive status are indeed unsafe (i.e., fewer false positives), but also increase the risk that some unsafe images may escape detection. In contrast, a lower threshold value may increase the likelihood that more unsafe images are detected, but with the increased risked that more safe images are also flagged with sensitive status.

According to some embodiments, the method further includes assigning an unsafe category to the product identifier associated with the image having the sensitive status. In step 516, server 306 does not apply the sensitive status to the image. In step 518, server applies the sensitive status to the image.

In some embodiments, information of products associated with images that are tagged with sensitive status may be stored in a separate database. By way of example, as depicted in FIG. 3, server 306 may store product information of products associated with images with sensitive status in unsafe DB 310. In some embodiments, products with information that are stored in unsafe DB 310 may be placed in an unsafe category in the other system database, such as CDS 304.

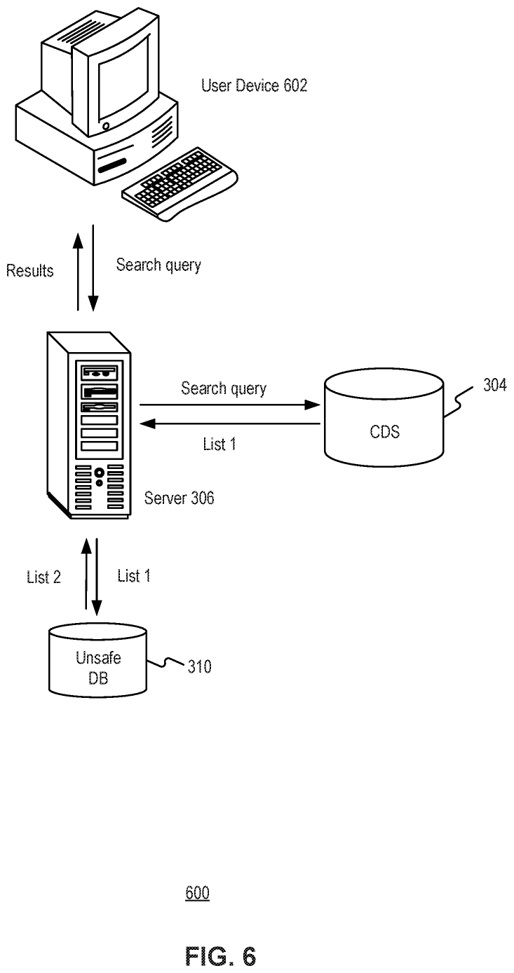

In some embodiments, the method further includes receiving, in response to a search query having a first matching criteria for products, results containing a plurality of product identifiers. A search query may be a request to locate information or data in a database. A computerized system may receive the search query, and perform searches using one or more search algorithm to find information or data that match the search query, based on matching criteria. Matching criteria may refer to a set of rules or logics for determining whether a piece of information or data is a match to the search query. For example, as depicted in FIG. 6, server 306 receives a search query from user device 602, and performs search for matching product in CDS 304. The results from CDS 304 is returned as list 1, which is a list of product identifier matching the search query based on first matching criteria.

In some embodiments, the method further includes determining that one of the plurality of product identifier of the results is the product identifier assigned to the unsafe category. For example, server 306 searches in unsafe DB 310 to determine if any of the product identifiers included in list 1 is also stored in unsafe DB 310. Upon determination, server 306 apply a second matching criteria to the product identifier assigned to the unsafe category; and if the second matching criteria fails, remove the product identifier assigned to the unsafe category from the results. For example, when server 306 determines that any product identifiers of list 1 is stored in unsafe DB 310, these product identifiers are returned from unsafe DB 310 in a separate list 2. For the product identifiers in list 2, server 306 performs an additional based on the search query using second matching criteria that is stricter than the first matching criteria.

For instance, the first matching criteria may to configured to allow for server 306 to include in the results, products that contain phrases or tags that matches the search query, thus may include products that are not exactly matching the search query. The second matching criteria may be configured such that server 306 only includes in the results, product identifiers in list 2 whose product name matches the search query. In another example, the second matching criteria may be configured to look for keywords such as ‘adult’, ‘erotica,’ ‘lingerie,’ or other such sensitive terms, and only include in the results, product identifiers in list 2, if these keywords are present in the search query. Server 306 may return results to user device 602. The results include product identifiers in list 1, minus any product identifier in list 2 that failed the second matching criteria. Server 306 may provide the results for display on a user device 602.

In some embodiments, the method further includes receiving a list containing a plurality of product identifiers to be displayed on a user device. The list may contain promotional products, or products associated with an advertising campaign. The list may be generated by server 306, or by another subsystem of system 100. In some embodiments, server 306 determines that one of the plurality of product identifiers is the product identifier assigned to the unsafe category. For example, server 306 may search unsafe DB 310 for any product identifier included in the list. Upon the determination, remove the product identifier assigned to the unsafe category from the list. For example, when server 306 determines that any of the product identifier included in the list is also stored in the unsafe DB, server 306 may remove those product identifiers from the list, and provide the updated the list for display on the user device 602.

While the present disclosure has been shown and described with reference to particular embodiments thereof, it will be understood that the present disclosure can be practiced, without modification, in other environments. The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments. Additionally, although aspects of the disclosed embodiments are described as being stored in memory, one skilled in the art will appreciate that these aspects can also be stored on other types of computer readable media, such as secondary storage devices, for example, hard disks or CD ROM, or other forms of RAM or ROM, USB media, DVD, Blu-ray, or other optical drive media.

Computer programs based on the written description and disclosed methods are within the skill of an experienced developer. Various programs or program modules can be created using any of the techniques known to one skilled in the art or can be designed in connection with existing software. For example, program sections or program modules can be designed in or by means of .Net Framework, .Net Compact Framework (and related languages, such as Visual Basic, C, etc.), Java, C++, Objective-C, HTML, HTML/AJAX combinations, XML, or HTML with included Java applets.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

1. A method for filtering products based on images, comprising the steps of:
receiving image data representing an image, the image being associated with a product identifier and an image type;
analyzing the image data by a plurality of machine learning models, each of the plurality of machine learning models having at least one different neural layer of nodes from the other ones of the plurality of machine learning models to capture different details from an input image, wherein the image data passes from one layer to the next layer through a sliding dot product operation between the layers;
generating a plurality of image scores for the image, each image score being generated by each of the plurality of machine learning models according to the corresponding image type;
determining, based on the plurality of image scores, whether the image has a sensitive status; and
assigning an unsafe category to the product identifier associated with the image having the sensitive status.

2. The method of claim 1, wherein the plurality of machine learning models comprises at least a neural network image classifier configured to detect nudity, and wherein the plurality of image scores comprises a first image score generated by the neural network image classifier.

3. The method of claim 2, wherein the plurality of machine learning models further comprises at least a convolutional neural network configured to detect objects, and wherein the plurality of image scores comprise a second image score generated by the convolutional neural network.

4. The method of claim 3, wherein the plurality of machine learning models further comprises at least a compound scaled convolutional neural network configured to detect objects, and wherein the plurality of image scores comprise a third image score generated by the compound scaled convolutional neural network.

5. The method of claim 1, wherein the plurality of image scores comprise a first image score, a second image score, and a third image score; and wherein the sensitive status is assigned based on a comparison between threshold values and the first image score, the second image score, and the third image score of the plurality of image scores.

6. The method of claim 5, wherein the threshold values of the plurality of image scores comprises a first threshold value, a second threshold value, and a third threshold value.

7. The method of claim 6, wherein threshold values depend on the image type of the image.

8. The method of claim 7, wherein the image type comprises at least one of fashion image, book image, and cartoon image.

9. The method of claim 1, further comprising the steps of:
receiving, in response to a search query having a first matching criteria for products, results containing a plurality of product identifiers;
determining that one of the plurality of product identifier of the results is the product identifier assigned to the unsafe category;
upon the determination:
apply a second matching criteria to the product identifier assigned to the unsafe category; and
if the second matching criteria fails, remove the product identifier assigned to the unsafe category from the results;
providing the results for display on a user device.

10. The method of claim 1, further comprising the steps of:
receiving a list containing a plurality of product identifiers to be displayed on a user device;
determining that one of the plurality of product identifier is the product identifier assigned to the unsafe category; and
upon the determination:
remove the product identifier assigned to the unsafe category from the list;
providing the list for display on the user device.

11. A computerized system for filtering products based on images, comprising:
at least one processor;
a memory comprising instructions that, when executed by the at least one processor, performs steps comprising:
receiving image data representing an image, the image being associated with a product identifier and an image type;
analyzing the image data by a plurality of machine learning models, each of the plurality of machine learning models having at least one different neural layer of nodes from the other ones of the plurality of machine learning models to capture different details from an input image, wherein the image data passes from one layer to the next layer through a sliding dot product operation between the layers;
generating a plurality of image scores for the image, each image score being generated by each of the plurality of machine learning models according to the corresponding image type;
determining, based on the plurality of image scores, whether the image has a sensitive status; and
assigning an unsafe category to the product identifier associated with the image having the sensitive status.

12. The system of claim 11, wherein the plurality of machine learning models comprises at least a neural network image classifier configured to detect nudity, and wherein the plurality of image scores comprises a first image score generated by the neural network image classifier.

13. The system of claim 12, wherein the plurality of machine learning models further comprises at least a convolutional neural network configured to detect objects, and wherein the plurality of image scores comprise a second image score generated by the convolutional neural network.

14. The system of claim 13, wherein the plurality of machine learning models further comprises at least a compound scaled convolutional neural network configured to detect objects, and wherein the plurality of image scores comprise a third image score generated by the compound scaled convolutional neural network.

15. The system of claim 11, wherein the plurality of image scores comprise a first image score, a second image score, and a third image score; and wherein the sensitive status is assigned based on a comparison between threshold values and the first image score, the second image score, and the third image score of the plurality of image scores.

16. The system of claim 15, wherein the threshold values of the plurality of image scores comprises a first threshold value, a second threshold value, and a third threshold value.

17. The system of claim 16, wherein threshold values depend on the image type of the image.

18. The system of claim 11, further comprising executing the steps of:
receiving, in response to a search query having a first matching criteria for products, results containing a plurality of product identifiers;
determining that one of the plurality of product identifier of the results is the product identifier assigned to the unsafe category;
upon the determination:
apply a second matching criteria to the product identifier assigned to the unsafe category; and
if the second matching criteria fails, remove the product identifier assigned to the unsafe category from the results;
providing the results for display on a user device.

19. The system of claim 11, further comprising executing the steps of:
receiving a list containing a plurality of product identifiers to be displayed on a user device;
determining that one of the plurality of product identifier is the product identifier assigned to the unsafe category; and
upon the determination:
remove the product identifier assigned to the unsafe category from the list;
providing the list for display on the user device.

20. A system for filtering items based on images, comprising;
one or more processors;
memory storage media containing instructions to cause the one or more processors to execute the steps of:
receiving information uploaded to a database, the information containing at least a product identifier and one or more images associated with the product identifier;
analyzing each of the one or more images by a plurality of machine learning models, each of the plurality of machine learning models having at least one different neural layer of nodes from the other ones of the plurality of machine learning models to capture different details from an input image, wherein the image data passes from one layer to the next layer through a sliding dot product operation between the layers, the plurality of machine learning models comprising:
a neural network nudity detector configured to generate a first image score;
a convolutional neural network object detector configured to generate a second image score; and
a compound scaled convolutional neural network object detector configured to generate a third image score;
determining based on the first image score, the second image score, and the third image score, whether each of the one or more images has a sensitive status; and
upon determination:
assigning an unsafe category to the product identifier associated with images having the sensitive status.
